(19) United States
(12) Patent Application Publication
(10) Pub. No.: US 2005/0143020 A1
(43) Pub. Date: Jun. 30, 2005

(54) TRANSCEIVER MODULE

(76) Inventors: Chuansheng Ren, Irvine, CA (US); Hongxi Xue, Rowland Heights, CA (US); En-Hsiang Yeh, Hsin-Chu City (TW)

Correspondence Address: NORTH AMERICA INTERNATIONAL PATENT OFFICE (NAIPC), P.O. BOX 506, MERRIFIELD, VA, 22116, US

(21) Appl. No.: 10/904,946

(22) Filed: Dec. 6, 2004

(30) Foreign Application Priority Data
Dec. 26, 2003 (TW) 092137014

(51) Int. Cl. H04B 1/44; H04B 1/02; H04B 1/00; H04M 1/00; H04B 1/38

(52) U.S. Cl. 455/83; 455/78; 455/91; 455/129

(57) ABSTRACT

The present invention discloses a transceiver module used in a wireless communication system. The transceiver module includes a transceiver IC, a T/R switch, and an amplification path electrically connected between the transceiver IC and the T/R switch. The transceiver IC includes an amplifier control unit, and a pre-amplifying unit electrically connected to the amplification path. The pre-amplifying unit pre-amplifies a first RF signal to generate a second RF signal. The amplification path amplifies the second RF signal to generate a third RF signal, and sends the third RF signal to the T/R switch. Wherein the transceiver module only uses one discrete power amplifier transistor in the amplification path to amplify the second RF signal.

### BACKGROUND

The present invention relates to a transceiver module, and more particularly, to a transceiver module that is used in a wireless communication system for processing RF signals.

Wireless communication has been a field undergoing rapid development in recent years. A mobile phone (or cellular phone) system is an example of wireless communication system. With the technology advancing from the second generation (2G) to the third generation (3G), an increasing number of functions are built inside the mobile phone handsets. Aside from providing the normal functions of a phone, some mobile phone handsets in the market also have built-in data transmission functions, multimedia applications, and even global positioning systems (GPS).

There are some key components that are always used in a wireless communication system. Taking cellular phone as an example, the basic components are base band (BB) modules, transceiver modules, and antennas. A base band module always includes a base band IC, and the primary task of which is to process the base band signals. For instance, voice or data signals are encoded/decoded by the base band IC. Normally, a transceiver module is connected to an antenna to transmit (or receive) RF signals through the antenna. A transceiver module always includes a RF transceiver IC (abbreviated as RF IC), a power amplifier module (abbreviated as PAM), a T/R switch, and several filters. FIG. 1 shows a schematic diagram of a conventional transceiver module. The transceiver module 100 receives a base band signal BB_OUT from a base band module (not shown), generates a radio frequency signal RF_OUT2 according to the base band signal BB_OUT, and transmits the signal RF_OUT2 through an antenna 10. The transceiver module 100 also receives a radio frequency signal RF_IN1 from the antenna 10, and then generates a base band signal BB_IN according to the radio frequency signal RF_IN1. The signal BB_IN will be further processed by the above mentioned base band module. For clarity, only one receive path and one transmit path are shown in FIG. 1, even though a transceiver module usually contains several receive paths and several transmit paths to process signals on different frequency bands (such as the frequency bands used in GSM-900, DCS-1800, or PCS-1900 systems).

The transceiver module 100 shown in FIG. 1 contains a T/R switch 110, a power amplifier module (PAM) 120, a filter 130, and a transceiver IC 140. The transceiver IC 140 receives a base band signal BB_OUT from a base band module (not shown in FIG. 1) and up-converts its frequency to generate a radio frequency signal RF_OUT1. The transceiver IC 140 also receives a radio frequency signal RF_IN2 from the filter 130 and down-converts its frequency to generate a base band signal BB_IN. The power amplifier module 120 is electrically connected between the transceiver IC 140 and the T/R switch 110. It receives the signal RF_OUT1 from the transceiver IC 140, amplifies the signal RF_OUT1 to generate a radio frequency signal RF_OUT2, and sends the signal RF_OUT2 to the T/R switch 110. The filter 130 is electrically connected between the T/R switch 110 and the transceiver IC 140. It receives a radio frequency signal RF_IN1 from the T/R switch 110, filters the signal RF_IN1 to generate a radio frequency signal RF_IN2, and sends the signal RF_IN2 to the transceiver IC 140 for further processing. Generally speaking, the filter 130 could be a surface acoustic wave filter (abbreviated as SAW filter).

Taking the widely used GSM-900, DCS-1800, PCS-1900 systems as an example, the power level of the radio frequency signal RF_OUT1 is roughly at a 1 mW level. However, after amplification by the power amplifier module 120, it is sometimes required that the power level of the radio frequency signal RF_OUT2 is at a 2W level. The amplification ratio is so high that power amplifier module must contain a plurality of GaAs heterojunction bipolar transistors (abbreviated as HBT) connected in series to complete the amplification task as described in the related art. In the example shown in FIG. 1, there are three power amplifiers connected in series. In addition, the power amplifier module 120 further comprises a power detector 124 and a comparator 125. The power detector 124 detects a power level of the radio frequency signal RF_OUT2. The comparator 125 compares the detected power level of the signal RF_OUT2 with a control level, and adjusts the amplification ratios of the power amplifiers 121, 122, 123 according to the comparing result. In some instances, the power detector 124 and the comparator 125 are circuit components formed by CMOS or BiCMOS.

Because the power amplifier module 120 contains more than one power amplifiers connected in series, and more than one manufacturing processes are used to produce the power amplifier module 120 (a HBT manufacturing process uses GaAs as the substrate to produce the power amplifiers 121, 122, 123, and a CMOS or BiCMOS manufacturing process uses silicon as the substrate to produce the power detector 124 and the comparator 125), the cost of each power amplifier module 120 is high. Further, every power amplifier module 120 is quite large. The result of this is that it is difficult to encapsulate the transceiver module 100 as a whole and reduce its IC size simultaneously. Theses problems are considered drawbacks of the related art.

Another drawback of the power amplifier module of the related art is that it has inferior power efficiency. FIG. 2 shows an example of a power efficiency curve of the power amplifier module 120 shown in FIG. 1. In GSM systems, the power amplifier module 120 is always designed such that it is capable of outputting RF signals with power levels up to 2W to endure an inferior environment. However, at most of the time, it is operated to output RF signals with power levels ranging from 10 mW to 100 mW. When the power level of the RF signals outputted by the power amplifier module 120 ranges from 10 mW to 100 mW, the power efficiency of the power amplifier module is quite poor. The lower the outputted power level is, the worse the power efficiency becomes. This situation not only increases the rate of power consumption which shortening handset standby time, but also causes the battery lifetime to decrease. This is also considered a drawback of the related art.

### SUMMARY

It is therefore an objective of the present invention to provide a transceiver module used in a wireless communication system to solve the above-mentioned problems.

According to an embodiment of the present invention, a transceiver module used in a wireless communication system is disclosed. The disclosed transceiver module comprises a transceiver IC, a T/R switch, and an amplification path electrically connected between the transceiver IC and the T/R switch. The transceiver IC comprises a pre-amplifier unit electrically connected to the amplification path. The pre-amplifier unit receives a first RF signal and amplifies the first RF signal to generate a second RF signal. The amplification path receives the second RF signal from the pre-amplifier unit, amplifies the second RF signal to generate a third RF signal, and sends the third RF signal to the T/R switch. The disclosed transceiver module uses only one discrete power amplifier transistor in the amplification path to amplify the second RF signal.

It is an advantage of the present invention that the disclosed transceiver module is smaller than that of the related art and the associated cost is also lower. Besides, it is easier to encapsulate the transceiver module as a whole. Another advantage of the present invention is that by operating it appropriately, the disclosed transceiver module has better power efficiency over a wider operating range than that of the related art.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a transceiver module of the related art.

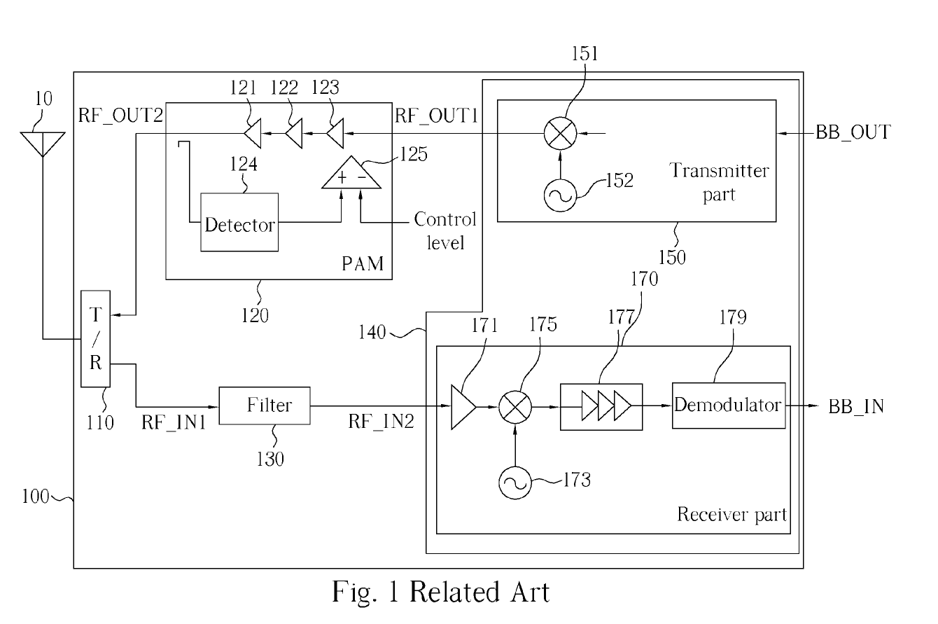

FIG. 2 is a plot of a power efficiency curve of the power amplifier module of the transceiver module of FIG. 1.

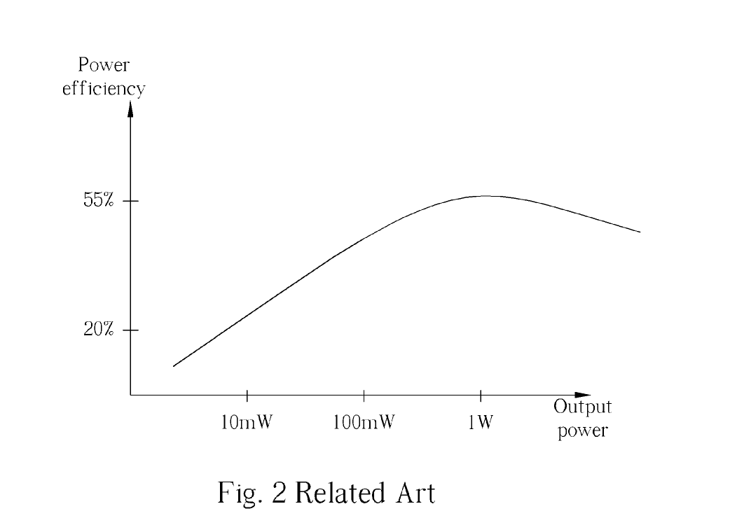

FIG. 3 is a schematic diagram of a transceiver module according to the present invention.

FIG. 4 is a plot of three power efficiency curves of the transceiver module of FIG. 3.

FIG. 5 is a plot of a power efficiency curve from the combination of three power efficiency curves of FIG. 4.

### DETAILED DESCRIPTION

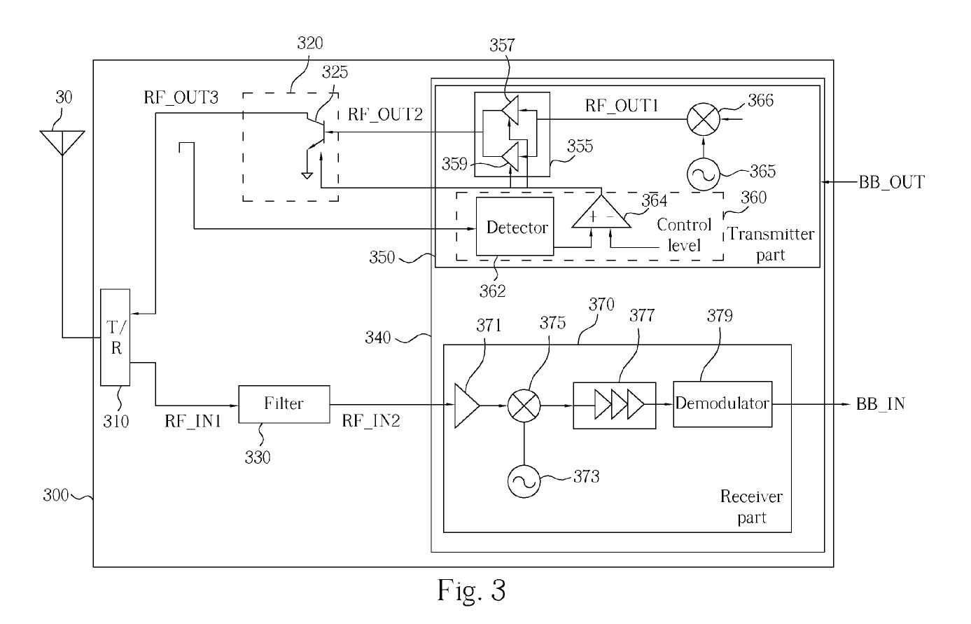

FIG. 3 shows a transceiver module according to an embodiment of the present invention. The transceiver module 300 receives a base band signal BB_OUT from a base band module (not shown), and generates a radio frequency signal RF_OUT3 according to the base band signal BB_OUT. It also receives a radio frequency signal RF_OUT3 from an antenna 30, and generates a base band signal BB_IN according to the radio frequency signal RF_OUT3. Please note that in FIG. 3, only a transmit path and a receive path of the transceiver module 300 for signal processing on a single frequency band are shown. However, it's also possible that the transceiver module of the present invention contains more than one transmit/receive paths for signal processing on a plurality of frequency bands.

In this embodiment, the transceiver module 300 includes a T/R switch 310, a transceiver IC 340, an amplification path 320, and a filter 330. The T/R switch 310 is used to switch the antenna 30 between a transmit state and a receive state. A transmitter part 350 of the transceiver IC 340 receives the base band signal BB_OUT, up-converts the frequency of the signal BB_OUT to generate a radio frequency signal RF_OUT1, and pre-amplifies the signal RF_OUT1 to generate a radio frequency signal RF_OUT2. A receiver part 370 of the transceiver IC 340 receives a radio frequency signal RF_IN2 from the filter 330, down-converts its frequency and then demodulates it to generate the base band signal BB_IN. The amplification path 320 is electrically connected between the transceiver IC 340 and the T/R switch 310. It receives the signal RF_OUT2 that is already pre-amplified by the transceiver IC 340, amplifies the signal RF_OUT2 to generate a radio frequency signal RF_OUT3, and sends the amplified signal RF_OUT3 to the T/R switch 310. The filter 330 is electrically connected between the T/R switch 310 and the transceiver IC 340. It receives the radio frequency signal RF_IN1 from the T/R switch 310, filters the signal RF_IN1 to generate a radio frequency signal RF_IN2, and sends the filtered signal RF_IN2 to the transceiver IC 340. As in the related art mentioned above, the filter 330 could be a SAW filter.

In the transceiver module 100 of the related art, a plurality of series-connected power amplifiers are set inside the integrated circuit of the power amplifier module 120 to amplify RF signals. However, in the present invention, only one discrete power amplifier transistor 325 is used in the amplification path 320 to amplifier RF signals. Wherein in the given examples, the power amplifier transistor 325 could be a circuit component with GaAs substrate, such as GaAs heterojunction bipolar transistor. Furthermore, since all the extra control circuits are set inside the transceiver IC 340, the size of the amplification path 320 in this embodiment will be much smaller than the power amplifier module 120 of the related art.

In this embodiment, the transceiver IC 340 contains a transmitter part 350 and a receiver part 370. Aside from components used to up-convert the frequency of the base band signal BB_OUT to generate the radio frequency signal FR_OUT1, the transmitter part 350 also contains a pre-amplifier unit 355 and an amplifier control unit 360. This point further makes the transceiver module 300 of this embodiment different from the related arts. The pre-amplifier unit 355 pre-amplifies the signal RF_OUT1 to generate the signal RF_OUT2. The amplifier control unit 360 controls the amplification ratios of the pre-amplifier unit 355 and the discrete power amplifier transistor 325. In some instances, both the pre-amplifier unit 355 and the amplifier control unit 360 could be circuit elements produced through manufacturing process using silicon substrate, such as CMOS manufacturing process or BiCMOS manufacturing process. Although the pre-amplifier unit 355 and the amplifier control unit 360 are set inside the transceiver IC 340, the cost and size of the transceiver IC 340 will increase only slightly since only manufacturing process using silicon substrate is used. Hence, by using only a discrete power amplifier transistor in the amplification path 320 and a Si-based transceiver IC 340, the total cost of the whole transceiver module will be lower than that of the related arts, and the total size will also be smaller.

In the embodiment shown in FIG. 3, there are two parallel-connected power amplifiers 357, 359 set inside the pre-amplifier unit 355. However, a design engineer can also connect the power amplifiers in series rather than in parallel. The number of power amplifiers set inside the pre-amplifier unit 355 depends on the need of amplifying RF signals. The amplifier control unit 360 in FIG. 3 contains a power detector 362 and a comparator 364. The power detector 362 is electrically connected to the amplification path 320 to detect a power level of the signal RF_OUT3 and it sends the detected power level to a comparator 364. The comparator 364 compares the detected power level of the signal RF_OUT3 from power detector 362 with a control level, and controls the amplification ratios of the power amplifiers 357, 358, and the discrete power amplifier transistor 325 according to the comparing result.

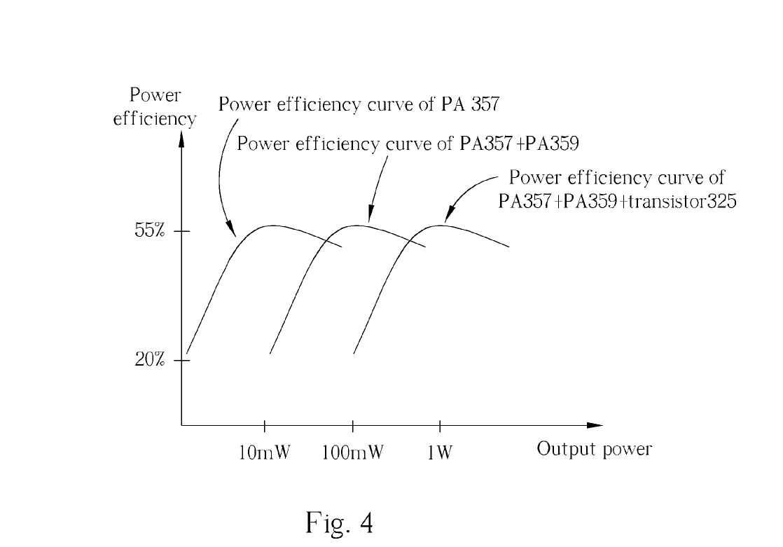

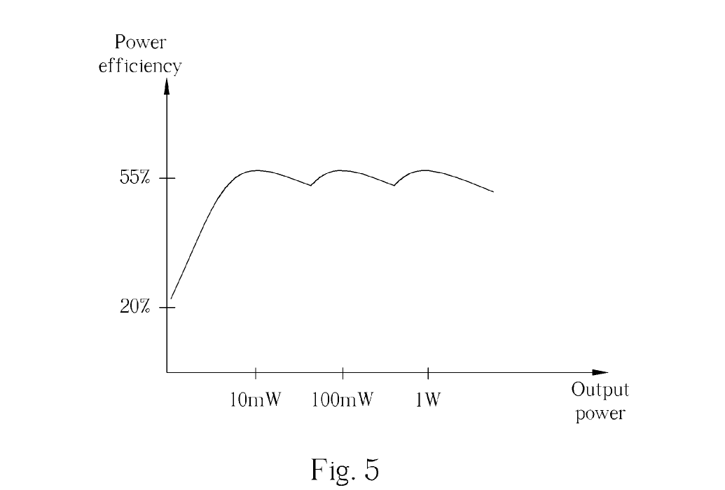

Furthermore, with the transceiver module 300 disclosed in this embodiment, the system can dynamically determine how to use the pre-amplifier unit 355 and the discrete power amplifier transistor 325 to amplify RF signals according to the amplification requirement. FIG. 4 shows three power efficiency curves the transceiver module 300 of FIG. 3 could have. The curve in the left hand side is the power efficiency curve when only the power amplifier 357 is used to amplify RF signals. The curve in the middle is the power efficiency curve when both the power amplifiers 357, 359 are used to amplify RF signals. And the curve in the right hand side is the power efficiency curve when the power amplifiers 357, 359 and the discrete power amplifier transistor 325 are all used to amplify RF signals. Apparently, by using different combination in different output power level range, the system will have a better power efficiency curve. Taking the curves shown in FIG. 4 as an example, the curve in the left hand side has a maximum power efficiency when output power is near 10 mW, the curve in the middle has a maximum one when output power is near 100 mW, and the curve in the right hand side has a maximum one when output power is near 1W. When the required power level of the signal RF_OUT3 is at a 10 mW level, the system can use only the power amplifier 357 to amplify RF signals, and turning off the power amplifier 359 and bypassing the discrete power amplifier transistor 325. When the required power level of the signal RF_OUT3 at a 100 mW level, the system can use both the power amplifiers 357 and 359 to amplify RF signals, and bypassing the discrete power amplifier transistor 325. When the required power level of the signal RF_OUT3 is at a 1W level, the system can use the power amplifiers 357, 359 and the discrete power amplifier transistor 325 as a whole to amplify RF signals. FIG. 5 shows a power efficiency curve of the transceiver module 300 when the above-mentioned switching method is applied. It is apparent that even when the required power level of the signal RF_OUT3 is not high (i.e. between 10 mW and 100 mW), the system still has good power efficiency, which is much better than that of the related art.

Although a transceiver module capable of transmitting and receiving RF signals is used as an example to illustrate the present invention, the present invention can also be applied in transmitters that cannot receive RF signals. By removing the receiver part 370 and the filter 330 shown in FIG. 3, the transceiver module 300 can become a transmitter module and still keep the characteristics of the present invention.

These and other objectives of the claimed invention will no doubt become obvious to those of ordinary skill in the art after reading the following detailed description of the preferred embodiment that is illustrated in the various figures and drawings. Accordingly, the above disclosure should be construed as limited only by the metes and bounds of the appended claims.

1. A transceiver module used in a wireless communication system, the transceiver module comprising:
a transceiver IC;
a T/R switch; and
at least one amplification path electrically connected between the transceiver IC and the T/R switch, for receiving a second RF signal from the transceiver IC, amplifying the second RF signal to generate a third RF signal, and sending the third RF signal to the T/R switch;
wherein only one discrete power amplifier transistor is used in the amplification path to amplify the second RF signal.

2. The transceiver module of claim 1, wherein the transceiver IC comprises:
a transmitter part, comprising:
at least one pre-amplifier unit, for receiving a first RF signal, pre-amplifying the first RF signal to generate the second RF signal; and
an amplifier control unit, for controlling the amplification ratios of the pre-amplifier unit and the discrete power amplifier transistor; and
a receiver part.

3. The transceiver module of claim 2, wherein the amplifier control unit comprises:
a power detector electrically connected to the amplification path, for detecting a power level of the third RF signal; and
a comparator electrically connected to the power detector, for comparing the power level of the third RF signal with a control level, and adjusting the amplification ratios of the pre-amplifier unit and the discrete power amplifier transistor according to the comparing result.

4. The transceiver module of claim 2, wherein the pre-amplifier unit comprises a plurality of parallel-connected CMOS amplifiers.

5. The transceiver module of claim 2, wherein the pre-amplifier unit comprises a plurality of serially connected CMOS amplifiers.

6. The transceiver module of claim 2, wherein the transceiver module further comprises a receiving path electrically connected between the T/R switch and the transceiver IC, for receiving a first input RF signal from the T/R switch, filtering the first input RF signal to generate a second input RF signal, and sending the second input RF signal to the transceiver IC.

7. The transceiver module of claim 6, wherein the receiving path comprises a SAW filter.

8. The transceiver module of claim 6, wherein the receiver part comprises:
a low noise amplifier electrically connected to the receiving path;
a local oscillator;
a mixer electrically connected to the low noise amplifier and the local oscillator;
a programmable gain amplifier electrically connected to the mixer; and
a demodulator electrically connected to the programmable gain amplifier.

9. The transceiver module of claim 1, wherein all the components in the transceiver IC are produced through a manufacturing process using silicon as the substrate.

10. The transceiver module of claim 9, wherein all the components in the transceiver IC are produced through a CMOS or BiCMOS manufacturing process.

11. The transceiver module of claim 1, wherein the discrete power amplifier transistor is produced through a manufacturing process using GaAs as the substrate.

12. The transceiver module of claim 11, wherein the discrete power amplifier transistor is a heterojunction bipolar transistor.

13. The transceiver module of claim 1, wherein the third RF signal is accordance with a GSM-900, DCS-1800, or PCS-1900 specification.

14. A radio frequency module used in a wireless communication system, comprising:
a radio frequency integrated circuit;
a T/R switch; and
a discrete power amplifier transistor electrically connected between the radio frequency integrated circuit and the T/R switch, for receiving a second RF signal from the radio frequency integrated circuit, amplifying the second RF signal to generate a third RF signal, and sending the third RF signal to the T/R switch.

15. The radio frequency module of claim 14, wherein the radio frequency integrated circuit comprises:
a pre-amplifier unit, for receiving a first RF signal, and for pre-amplifying the first RF signal to generate the second RF signal; and
an amplifier control unit, for controlling the amplification ratios of the pre-amplifier unit and the discrete power amplifier transistor.

16. The radio frequency module of claim 15, wherein the amplifier control unit comprises:
a power detector electrically connected to the discrete power amplifier transistor, for detecting a power level of the third RF signal; and
a comparator electrically connected to the power detector, for comparing the power level of the third RF signal with a control level, and for adjusting the amplification ratios of the pre-amplifier unit and the discrete power amplifier transistor according to the comparing result.

17. The radio frequency module of claim 15, wherein the radio frequency module a radio frequency transceiver IC comprises a radio frequency receiver part and a radio frequency transmitter part, wherein both the pre-amplifier unit and the amplifier control unit are set inside the radio frequency transmitter part.

18. The radio frequency module of claim 14, wherein all the components in the RF IC are produced through a manufacturing process using silicon as the substrate.

19. The radio frequency module of claim 18, wherein all the components in the RF IC are produced through a CMOS or BiCMOS manufacturing process.

20. The radio frequency module of claim 14, wherein the discrete power amplifier transistor is produced through a manufacturing process using GaAs as the substrate.

21. The radio frequency module of claim 20, wherein the discrete power amplifier transistor is a heterojunction bipolar transistor.

22. The radio frequency module of claim 14, wherein the RF IC is a RF Transmitter IC.

23. An RF module used in a wireless communication system, comprising:
an RF IC;
a T/R switch; and
a power amplifier module electrically connected between the RF IC and the T/R switch, for receiving a second RF signal from the RF IC, amplifying the second RF signal to generate a third RF signal, and sending the third RF signal to the T/R switch;
wherein the power amplifier module comprises at least one discrete transistor produced through a manufacturing process using GaAs as the substrate, and none of the components in the power amplifier module are produced through a manufacturing process using silicon as substrate.

24. The RF module of claim 23, wherein the power amplifier module contains only one GaAs heterojunction bipolar transistor.

25. A RF module used in a cellular communication system, comprising:
a RF IC;
a T/R switch; and
a discrete power amplifier transistor electrically connected between the RF IC and the T/R switch, for receiving a RF signal from the RF IC, amplifying the RF signal until a power of the RF signal approaches a power limit of the cellular communication system, and sending the amplified RF signal to the T/R switch.

26. The radio frequency module of claim 25, wherein all the components in the RF IC are produced through a manufacturing process using silicon as the substrate.

27. The radio frequency module of claim 25, wherein the discrete power amplifier transistor is a GaAs heterojunction bipolar transistor.

28. A RF module used in a cellular communication system, comprising:
a RF IC;
a T/R switch; and
a discrete power amplifier transistor electrically connected between the RF IC and the T/R switch, for receiving a second RF signal from the RF IC, amplifying the second RF signal to generate a third RF signal, and sending the amplified RF signal to the T/R switch, wherein the third RF signal has a power level approaching a power limit of the cellular communication system;
wherein the power amplifier module comprises at least one discrete GaAs heterojunction bipolar transistor and no component produced through a CMOS manufacturing process.

29. The RF module of claim 28, wherein the power amplifier module contains only one GaAs heterojunction bipolar transistor.
